(19) United States
(12) Patent Application Publication
(10) Pub. No.: US 2017/0096910 A1
(43) Pub. Date: Apr. 6, 2017

(54) Turbine Engine Oil Reservoir with Deaerator

(71) Applicant: Safran Aero Boosters SA, Herstal (BE)

(72) Inventors: Nicloas Raimarckers, Tourine (Braives) (BE); Bruno Servais, Braives (BE); Albert Cornet, Verviers (BE); Stéphane Bougelet, Profondeville (BE)

(21) Appl. No.: 15/281,716

(22) Filed: Sep. 30, 2016

(30) Foreign Application Priority Data
Oct. 2, 2015 (BE) 2015/5611

(51) Int. Cl. F01D 25/20; B04C 9/00; B04C 5/04; B01D 19/00; B01D 46/00

(52) U.S. Cl. CPC F01D 25/20; B01D 19/0057; B01D 46/0056; B04C 5/04; B04C 9/00; F01D 25/183

(57) ABSTRACT

A turbine engine reservoir has an oil deaerating device. The oil deaerating device includes a deaeration chamber for an air-oil mixture; an inlet of the air-oil mixture with a tangential inlet channel to form a vortex in the air-oil mixture contained in the chamber; and a vent for the discharge of air as a result of the deaeration of the air-oil mixture. The vent includes a rotor driven in rotation by the circulation of the air-oil mixture in the region of the inlet. The rotor filters the degassed air loaded with oil droplets in suspension. By centrifugal force, the rotor returns the collected oil onto the internal surface of the conduit of the vent. The collected oil drops back down into the chamber as a result of gravity.

This application claims priority under 35 U.S.C. §119 to Belgium Patent Application No. 2015/5611, filed 2 Oct. 2015, titled “Turbine Engine Oil Reservoir with Deaerator,” which is incorporated herein by reference for all purposes.

### BACKGROUND

1. Field of the Application

The present application relates to the field of oil deaerating devices. More specifically, the present application relates to an engine oil reservoir provided with a deaerator and a vent for discharging gas removed from the oil. The present application further proposes a turbine engine, in particular an airplane turbojet engine or an aircraft turboprop.

2. Description of Related Art

A multiflow turbojet engine comprises a plurality of independent rotors which are articulated relative to the stator chamber. The pivot connections thereof are implemented by a plurality of lubricated bearings in chambers where an oil mist prevails. Oil is projected onto the rolling bearings and is then collected in order to return to the oil reservoir of the turbojet engine. During operation, an air-oil mixture is formed and reduces the performance of the oil.

In order to reduce the effects of air bubbles in this mixture, the reservoir is connected to a deaerating device permitting the air to be separated from the oil and then permitting the air to be returned to the environment. A deaerating device may be of the static type and operate according to a vortex principle, where the air-oil mixture spins inside the reservoir to promote the separation of the two phases.

The document EP1297875A1 discloses a lubrication circuit of a turbojet engine with a dry housing. The circuit is provided with a deaerating device for an air-oil mixture integrated in the oil reservoir of the turbojet engine. The rotational movement of the oil inside a tank permits the air to be removed therefrom. This air is then discharged by means of a vent in the upper part. The deaerating device is also provided with a restrictor controlling the circulation via the vent. The restrictor is connected to a float carried by the oil level which enables it to be adapted both to the flow rate and to the air content of the air-oil mixture.

However, the air discharged by the vent generally comprises oil in the form of droplets. The release of these droplets into the surroundings increases the consumption of oil of the turbojet engine and thus increases the quantity of oil which has to be stored so that the oil does not run out. This is not satisfactory since the turbojet engine is heavier and the corresponding aircraft consumes more fuel for the lift.

Although great strides have been made in the area of oil deaerating devices, many shortcomings remain.

### DESCRIPTION OF THE DRAWINGS

FIG. 1 shows an axial turbine engine according to the present application.

FIG. 2 shows a diagram of an oil reservoir according to the present application according to a first embodiment of the present application.

FIG. 3 illustrates a vent according to a second embodiment of the present application.

### DETAILED DESCRIPTION OF THE PREFERRED EMBODIMENT

The present application aims to solve at least one of the problems posed by the prior art. More specifically, one subject of the present application is to reduce the oil losses of a deaerating device. Another subject of the present application is to improve the operation of an oil circuit. Another subject of the present application is to propose a simple, strong, lightweight, economical and reliable solution.

The subject of the present application is an oil deaerating device, in particular for an oil reservoir, the oil deaerating device comprising: a deaeration chamber for a liquid air-oil mixture; an inlet for the mixture into the chamber; a vent permitting communication between the chamber and the surroundings of the device so as to discharge the air from the deaeration of the air-oil mixture into the surroundings; which is noteworthy in that in the region of the vent it comprises a rotor which is configured to permit the collection of oil droplets in suspension in the deaerated air discharged by the vent.

According to one advantageous embodiment of the present application, the vent comprises a conduit surrounding the rotor, in the normal direction of assembly the oil present on the internal surface of the conduit potentially returning by gravity into the chamber.

According to one advantageous embodiment of the present application, the device is configured so that the rotation of the rotor causes the centrifuging of the deaerated air discharged via the vent.

According to one advantageous embodiment of the present application, the rotor comprises a driven portion, in particular in the form of a wheel or screw, capable of being driven in rotation by the circulation of the air-oil mixture, in particular in the region of the inlet.

According to one advantageous embodiment of the present application, the driven portion is arranged opposite the oil inlet.

According to one advantageous embodiment of the present application, the driven portion is arranged inside the oil inlet.

According to one advantageous embodiment of the present application, the driven portion comprises an annular row of blades extending axially or radially relative to the axis of rotation of the rotor.

According to one advantageous embodiment of the present application, the rotor comprises a filtering portion consisting of foam and arranged inside the vent, in particular inside the internal surface.

According to one advantageous embodiment of the present application, the vent comprises a foam layer fixed to the chamber, said layer being opposite the rotor, potentially downstream of or around the rotor.

According to one advantageous embodiment of the present application, the vent comprises a plurality of foam layers fixed to the chamber, the rotor comprising at least one foam disc, preferably a plurality of foam discs, the layers and each rotor disc alternating with one another.

According to one advantageous embodiment of the present application, the inlet comprises an inlet channel which opens tangentially into the chamber.

According to one advantageous embodiment of the present application, the inlet comprises a module for reducing its passage cross section so as to be able to increase the speed of flow of the mixture at that point.

According to one advantageous embodiment of the present application, the device comprises a heat exchanger module.

According to one advantageous embodiment of the present application, the vent is at the same level as the oil inlet.

According to one advantageous embodiment of the present application, the pipe is more long than width; optionally the pipe length is longer than the pipe diameter.

According to one advantageous embodiment of the present application, the chamber comprises a pocket of reduced width, which may be cylindrical, the rotor being arranged therein and/or the inlet of the air-oil mixture opening into said pocket.

According to one advantageous embodiment of the present application, the rotor is at least partially arranged in the vent.

According to one advantageous embodiment, the internal volume of the chamber is greater than 0.50 L, preferably greater than or equal to 3 L, more preferably greater than or equal to 20 L, possibly greater than or equal to 40 L.

According to one advantageous embodiment of the present application, the reservoir has a generally curved shape, preferably the reservoir forms a curved cylinder or a curved plate.

According to one advantageous embodiment of the present application, the vent comprises an internal surface surrounding the rotor and/or opposite the rotor, said surface being capable of collecting the oil droplets.

According to one advantageous embodiment of the present application, in the normal direction of assembly the vent is arranged in the upper part of the chamber.

According to one advantageous embodiment of the present application, the reservoir comprises a partition delimiting the chamber, the partition possibly being of uniform thickness.

According to one advantageous embodiment of the present application, the reservoir comprises a refilling plug, in particular in the upper part in the normal direction of assembly, and preferably the reservoir has an elongated shape with two opposing principal ends, the vent and the plug being at the same end.

According to one advantageous embodiment of the present application, at least one foam or each foam or a plurality of foams are metal foams.

According to one advantageous embodiment of the present application, the rotor is primarily or entirely retained in the chamber. The proportion is measured in weight or longitudinally along the axis of rotation of the rotor.

According to one advantageous embodiment of the present application, the driven portion forms a turbine capable of receiving mechanical work provided by the circulation of the air-oil mixture.

According to one advantageous embodiment of the present application, the device comprises an outlet for degassed oil, which may oppose the inlet and/or the vent.

According to one advantageous embodiment of the present application, the inlet channel is capable of permitting a flow of the air-oil mixture tangentially to the internal surface of the chamber and/or is capable of forming a vortex in the air-oil mixture contained in the chamber.

According to one advantageous embodiment of the present application, the device is configured so that the rotation of the rotor causes the projection of the oil droplets in suspension in the air against the internal surface of the vent, in particular by centrifugal force.

The deaerator function is not indispensable to the present application. The present application further proposes an oil reservoir, in particular for a turbine engine, the reservoir comprising: a chamber designed to contain oil, in particular a deaeration chamber for an air-oil mixture; an inlet for the mixture in the chamber; a vent in communication with the inlet of the mixture via the chamber and/or permitting communication between the chamber and the surroundings of the reservoir; which is noteworthy in that it comprises in the region of the vent a rotor which is configured to permit the collection of oil droplets in suspension in the air passing through said rotor.

The subject of the present application is also a turbine engine comprising an oil deaerating device which is noteworthy in that the oil deaerating device is in accordance with the present application, and preferably the turbine engine comprises an oil circuit with a pump in communication with the oil deaerating device; and/or the turbine engine comprises a reservoir according to the present application.

According to one advantageous embodiment of the present application, the turbine engine comprises two concentric annular walls radially spaced apart from one another, the device being arranged between said walls.

According to one advantageous embodiment of the present application, the oil circuit further comprises lubrication chambers with bearings and seals.

According to one advantageous embodiment of the present application, the pump is configured so that the pressure of the air-oil mixture at the inlet is greater than or equal to 0.5 bar, preferably greater than or equal to 3 bar, preferably greater than or equal to 7 bar.

According to one advantageous embodiment of the present application, the reservoir follows the contour of at least one of the annular walls, preferably each annular wall.

According to one advantageous embodiment of the present application, the pump is arranged downstream of the deaerating device and forces back the pressurised mixture via the inlet of the reservoir.

According to one advantageous embodiment of the present application, the turbine engine comprises a high-pressure compressor with an external housing, the reservoir being arranged axially in the region of said high-pressure compressor and possibly being fixed to said external housing.

According to one advantageous embodiment of the present application, the pump is a volumetric pump.

Generally, the advantageous embodiments of each subject of the present application are also applicable to further subjects of the present application. Where possible, each subject of the present application is able to be combined with further subjects.

The present application makes it possible to treat the flow via the vent and to make the released air cleaner. The liquid phase present in the air is collected, which avoids any salting out. The rotor permits the oil droplets to be collected directly and indirectly. The foam agitates the gas in the vent so that the droplets are bonded thereto. The turbulence created in the vent permits the droplets to be projected against the surface of the vent. This surface collects the droplets and provides a support so that they flow towards the chamber.

The solution provided by the present application is simple and reliable since it only requires a single element which operates passively. No external energy source is required, to the extent that the flow of the mixture suffices for the rotation of the rotor. This operation is low in energy since the energy removed from the mixture is designed to be dissipated. The action of gravity is also involved in energy saving and in reliability.

In the description which follows, the terms interior or internal and exterior or external refer to a positioning which is relative to the axis of rotation of an axial gas turbine engine. The axial direction corresponds to the direction along the axis of rotation of a rotor of the vent. The radial direction is perpendicular to the axis of rotation.

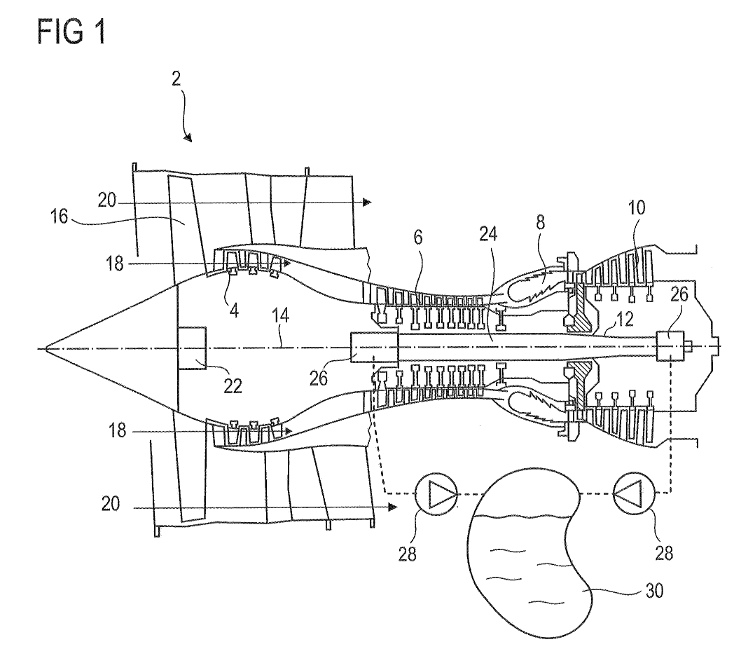

FIG. 1 shows in a simplified manner an axial turbine engine. In this specific case it is a bypass turbojet engine. The turbojet engine 2 comprises a first compression stage, called the low-pressure compressor 4, a second compression stage, called the high-pressure compressor 6, a combustion chamber 8 and one or more turbine stages 10. During operation, the mechanical power of the turbine 10 transmitted via the central shaft to the rotor 12 sets the two compressors 4 and 6 in motion. These two compressors comprise a plurality of rows of rotor blades associated with rows of stator blades. The rotation of the rotor about its axis of rotation 14 thus permits an air flow to be generated and said air flow to be progressively compressed as far as the inlet of the combustion chamber 8.

An inlet ventilating fan, commonly denoted a fan or blower 16, is coupled to the rotor 12 and generates an airflow which is divided into a primary flow 18 passing through the aforementioned different stages of the turbine engine and a secondary flow 20 passing through an annular conduit (partially shown), along the machine so as to join the primary flow at the turbine outlet. Gear reduction means, such as an epicyclic reduction gear 22, may reduce the speed of rotation of the blower 16 and/or the low-pressure compressor 4 relative to the associated turbine 10. The secondary flow 20 may be accelerated so as to generate a thrust reaction.

The primary flow 18 and the secondary flow 20 are radially concentric annular flows. The progressive circulations thereof become possible due to a plurality of rotors 12 with separate shafts 24. These shafts 24 may be coaxial and fitted into one another. The shafts are mobile in rotation via bearings 26 at the interfaces thereof with the housing of the turbine engine 2, or even by means of bearings at their common interfaces.

The cooling and/or lubrication of the bearings 26 and the optional epicyclic reduction gear 22 are provided by an oil circuit which may be closed. This oil circuit may also supply actuators such as hydraulic cylinders (not shown). The oil circuit may also comprise a heat exchanger (not shown) to cool the oil. The bearings 26 are arranged in chambers which are generally sealed using seals around the shafts, where they are sprayed with oil. In contact with the bearings 26, the oil is loaded with air so that the collected oil becomes a liquid air-oil mixture, for example with at least 1% air by volume.

Since the chambers potentially form dry housings, said chambers are provided with suction orifices, also called drainage orifices, in communication with pumps 28. The pumps 28 may be of the volumetric pump type, for example to control the flow rate. The oil circuit may thus comprise a plurality of oil collection lines converging towards a reservoir 30 which might be the principal reservoir. The reservoir 30 is also the starting point for a plurality of supply lines (not shown) of the bearings 26 and various pieces of equipment. The reservoir 30 may be fixed to the nacelle of the turbine engine. It may be placed between two annular walls guiding the concentric flows; for example, the secondary flow 20 and the flow surrounding the turbine engine or the primary flow 18 and the secondary flow 20.

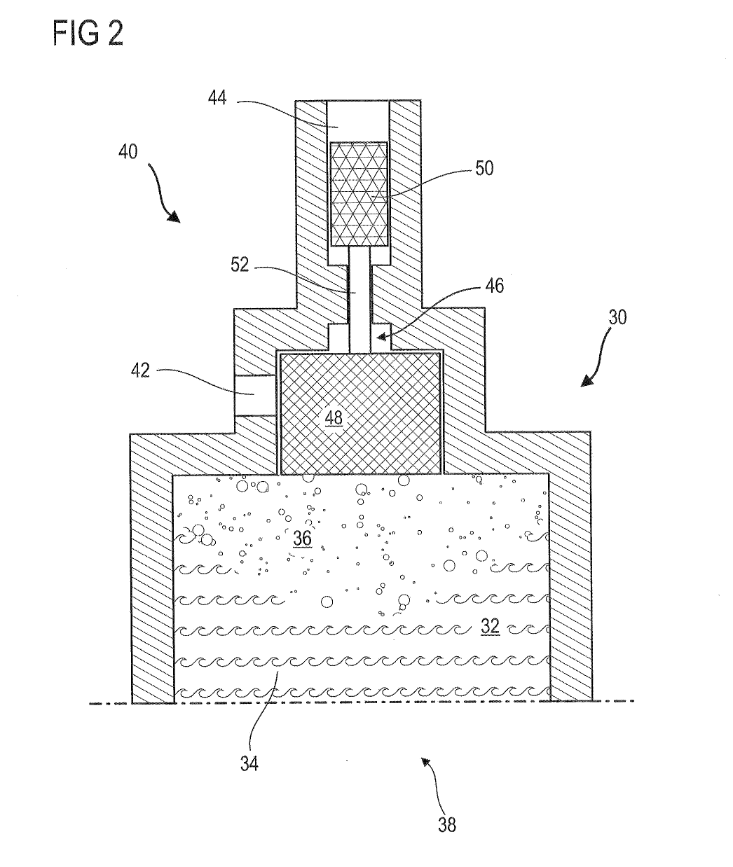

FIG. 2 is a sectional view of an upper portion of an oil reservoir 30 as in FIG. 1. The reservoir 30 is partially filled, its lower part 32 containing a liquid air-oil mixture 34 and the upper part 36 containing a primarily gaseous phase in which the oil droplets are in suspension.

The reservoir 30 forms a chamber 38 such as a container with a usable volume to contain the oil. The reservoir 30 is provided with a deaerating device 40 permitting the air to be separated from the oil combined in the mixture 34. The inlet 42 of the air-oil mixture 34 may be produced tangentially to the internal surface of the chamber 38. As a result, the speed of intake of the mixture 34 in the chamber 38 generates a rotational movement of the quantity of oil already present in the chamber 38. A vortex is created and the gas-liquid interface becomes parabolic. The air bubbles of the mixture 34 tend to return to the interface. The oil deprived of air becomes denser and is concentrated in the lower part of the chamber, against the wall thereof. Here the oil which has become homogenous is removed to be reused in the equipment of the oil circuit.

The reservoir 30 comprises a vent 44. Said vent may be occupied by the deaeration device 40. The communication between the chamber 38 and the vent 44 may be implemented via the deaeration device 40. The vent 44 comprises a rotor 46. The vent 44 may form a pipe or a duct around the rotor 46. The axis of rotation thereof may be in the direction of circulation of the air leaving the reservoir 30 via the vent 44.

The rotor 46 may comprise a driven portion 48 receiving at least one portion of the kinetic energy of the air-oil mixture 34 at the inlet 42. This driven portion benefits from the dynamic pressure of the mixture and permits the rotational movement of the rotor. The driven portion 48 converts the movement of the mixture 34 into a rotational movement of the rotor 46. The driven portion 48 may consist of foam. It may be a disc with an annular row of blades or scoops which receive and collect the energy from the flow of the mixture 34.

The passage cross section of the inlet 42 may be calibrated to drive the rotor 46 at a predetermined rotational speed. The inlet is possibly provided with a module reducing its passage cross section in order to accelerate the speed of intake of the mixture and thus to control the speed of rotation of the rotor. The driven portion 48 may be arranged in a dedicated pocket of the chamber 38; and the internal surface of the pocket may generally follow the contour of the driven portion 48. The inlet 42 of the mixture 34 may open into the pocket so as to come into contact with the driven portion 48, actuating said driven portion.

The rotor 46 comprises a filtering portion 50, for example arranged in the vent 44 or at the inlet of the vent. The filtering portion 50 may consist of foam, possibly metal foam. The communicating pores of the foam permit the deaerated air to pass through the rotor 46 and to escape via the vent 44. The filtering portion 50 is connected to the driven portion 48 via a rod 52 which is movably mounted in rotation relative to the wall of the reservoir 30 and, in particular, the conduit of the vent 44.

The rotational movement of the filtering portion 50 permits several actions. It permits the oil collected by the filtering portion 50 to be removed by centrifuging and to project this oil against the internal surface of the vent 44. In the normal direction of assembly, the oil projected against the internal surface drops down from the conduit by gravity into the chamber 38 and is added to the volume of oil which is already present there. The rotational movement also drives the deaerated air in rotation, so that the droplets in suspension clump together on the internal surface of the conduit of the vent. This is also the result of centrifugal force, which precedes the gravitational force which permits the return of the oil into the chamber 38 arranged lower down. It is noteworthy that the driven portion may contribute to the rotation of air in the vent 44.

The internal surface of the conduit of the vent 44 is opposite the rotor 46 and surrounds said rotor. It may be smooth or may be covered with foam, collecting the oil droplets all around the rotor. The oil which is collected at that point is then able to flow in order to return to the chamber 38.

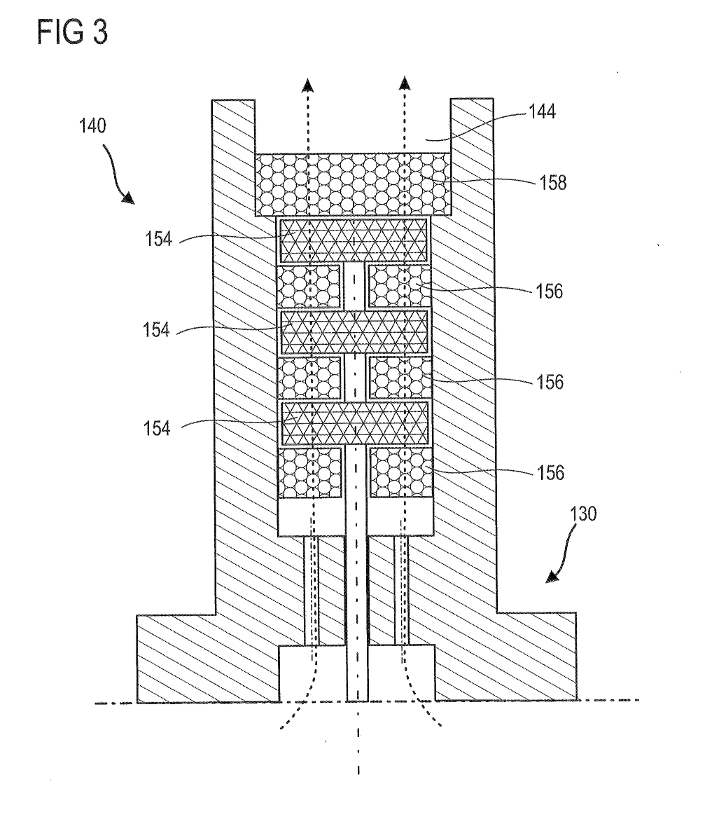

FIG. 3 shows an upper part of the reservoir 130 with a deaerating device 140 according to a second embodiment of the present application. This FIG. 3 reproduces the numbering of the preceding figures for identical or similar elements, the numbering being increased however by 100. Specific numbers are used for elements which are relevant to this embodiment.

The rotor 146 comprises a plurality of discs 154 agitating the air in the vent 144. The discs drive in rotation the air passing through the vent 144. The discs 154 may consist of foam. They may be separated from one another. Stator foam layers (156; 158) may be interposed between the discs 154 of the rotor 144, for example, so as to form alternate layers 156; 158 and discs 154. At the outlet, the vent 144 may have an outlet layer 158 forming a porous plug collecting the droplets.

The present application has been disclosed in relation to a reservoir provided with a deaerating device. However, it is conceivable to apply the present application to a reservoir without a deaerating device. A rotor may be placed in a passage connecting the inlet to the vent, without the chamber of the reservoir directly promoting deaeration. The deaerating device may also be a separate piece of equipment, spaced apart from the reservoir. Alternatively, the deaerating device may be integrated in the heat exchanger, for example the collector thereof may form a chamber. It may be integrated in a pump.

It is also conceivable that the rotor comprises a driven portion which is introduced into the inlet or which is upstream of the inlet. The vent may be located in the extension of the rotor and thus in the extension of the inlet. In the normal direction of assembly, as in the case of the vent the rotor may be horizontal or substantially inclined relative to the horizontal. An inclined spout may be added for returning the oil by gravity into the chamber. The vent may be offset relative to the axis of rotation of the rotor. The rotor may be outside the vent. The driven portion may be arranged so as to be partially in contact with the parabolic interface between the liquid and the gas.

We claim:

1. An oil reservoir, comprising:
an oil deaerating device with a deaeration chamber for an air-oil liquid mixture;
an inlet for the mixture into the chamber;
a vent permitting communication between the chamber and the surroundings of the oil reservoir so as to discharge the air from the deaeration of the air-oil mixture into the surroundings; and
a rotor disposed within the vent for permitting collection of oil droplets in suspension in the deaerated air discharged through the vent.

2. The oil reservoir in accordance with claim 1, wherein the vent comprises:
a conduit surrounding the rotor, in the normal direction of assembly the oil present on the internal surface of the conduit potentially returning by gravity into the chamber.

3. The oil reservoir in accordance with claim 1, wherein the rotation of the rotor causes the centrifuging of the deaerated air discharged via the vent.

4. The oil reservoir in accordance with claim 1, wherein the rotor comprises:
a driven portion, intended to drive in rotation by the circulation of the air-oil mixture.

5. The oil reservoir in accordance with claim 4, wherein the driven portion is arranged opposite the inlet of the air-oil mixture.

6. The oil reservoir in accordance with claim 4, wherein the driven portion is arranged inside the inlet of the air-oil mixture.

7. The oil reservoir in accordance with claim 4, wherein the driven portion comprises:
an annular row of blades extending axially or radially relative to the axis of rotation of the rotor.

8. The oil reservoir in accordance with claim 1, wherein the vent comprises:
a pipe around the rotor.

9. The oil reservoir in accordance with claim 1, wherein the inlet comprises:
an inlet channel which opens tangentially into the chamber.

10. The oil reservoir in accordance with claim 1, wherein the inlet comprises:
a module for reducing a passage cross section of the inlet, so as to be able to increase the speed of flow of the mixture at that point.

11. The oil reservoir in accordance with claim 1, further comprising:
a heat exchanger module.

12. The oil reservoir in accordance with claim 1, wherein the vent is at the same level as the inlet of the air-oil mixture.

13. The oil reservoir in accordance with claim 1, wherein the chamber comprises:
a pocket of reduced width, the rotor being arranged therein.

14. The oil reservoir in accordance with claim 1, wherein the chamber comprises:
a cylindrical pocket of reduced width, the inlet of the air-oil mixture opening into said pocket.

15. An oil deaerating device, comprising:
a deaeration chamber for a liquid air-oil mixture;
an inlet for the mixture into the chamber;
a vent permitting communication between the chamber and the surroundings of the device so as to discharge the air from the deaeration of the air-oil mixture into the surroundings;
wherein in the region of the vent, the oil deaerating device comprises:
a rotor adapted for collection of oil droplets in suspension in the deaerated air discharged through the vent, the vent comprising:
a foam layer facing the rotor.

16. The oil deaerating device in accordance with claim 15, wherein the vent further comprises:
a plurality of foam layers fixed to the chamber, the rotor comprising:
at least one foam disc, the layers and each rotor disc alternating with one another.

17. A turbine engine, comprising:
an oil deaerating device comprising:
a deaeration chamber for a liquid air-oil mixture;
an inlet for the mixture into the chamber;
a vent permitting communication between the chamber and the surroundings of the turbine engine so as to discharge the air from the deaeration of the air-oil mixture into the surroundings;
wherein level the vent, the oil deaerating device comprises:
a rotor adapted for collection of oil droplets in suspension in the deaerated air discharged through the vent, the rotor being in flow communication with the turbine engine surroundings.

18. The turbine engine in accordance with claim 17, further comprising:
two concentric annular walls radially spaced apart from one another, the oil deaerating device being arranged between the walls.

19. The turbine engine in accordance with claim 17, further comprising:
an oil circuit in communication with the deaeration chamber, the oil circuit comprising:
a pump; and
lubrication chambers with bearings and seals.

20. The turbine engine in accordance with claim 19, wherein the pump is configured so that the pressure of the air-oil mixture at the inlet is at least 0.5 bar.
